(19) United States
(12) Patent Application Publication
(10) Pub. No.: US 2014/0058825 A1
(43) Pub. Date: Feb. 27, 2014

(54) AUGMENTED-REALITY-BASED OFFER MANAGEMENT SYSTEM

(71) Applicants: Madhusudan Raman, Sherborn, MA (US); Peter Steven Tippett, Great Falls, VA (US)

(72) Inventors: Madhusudan Raman, Sherborn, MA (US); Peter Steven Tippett, Great Falls, VA (US)

(73) Assignee: VERIZON PATENT AND LICENSING INC., Basking Ridge, NJ (US)

(21) Appl. No.: 13/593,651

(22) Filed: Aug. 24, 2012

(51) Int. Cl. G06Q 30/02

(52) U.S. Cl. 705/14.42; 705/14.58; 705/14.55

(57) ABSTRACT

A network device receives location information from a user device and identifies, from an index of offers, a set of offers applicable in proximity to the location. Each offer in the set of offers includes location data to associate the offer with a particular geographic location. The network device sends, to the user device, at least a portion of set of offers as a default offer set. The user device store user preferences for advertising categories and presents, to a user, a reality image from the location of the user device. The user device selects—based on the user preferences, the reality image, and the location data—offers in the default offer set that are applicable to a user of the user device. The user device displays indications of the applicable offers overlaid on a portion of the reality image and makes the indications available for selection by the user.

### BACKGROUND

Proximity-based advertisements attempt to target users who are in the geographical area of a business that is being advertised. In some instances, advertising systems may enable user device users to opt in to receive advertising based on the location of the user device. However, there remains room for improvement in how proximity-based advertising is managed and targeted to particular consumers.

### BRIEF DESCRIPTION OF THE DRAWINGS

FIG. 1 is a diagram of illustrating concepts described herein;

FIG. 2 is a diagram illustrating an exemplary network in which systems and/or methods described herein may be implemented;

FIG. 3 is a block diagram illustrating exemplary components of a device that may correspond to one of the devices of FIG. 2;

FIG. 4 is a block diagram illustrating exemplary functional components of the user device of FIG. 1;

FIG. 5 is a block diagram illustrating exemplary functional components of the exchange server of FIG. 1;

FIG. 6 is a diagram illustrating exemplary communications between devices in a portion of the network of FIG. 1;

FIGS. 7 and 8 are flow diagrams of an exemplary process for presenting offers via a user device in an augmented-reality-based system; and

FIG. 9 is a flow diagram of an exemplary process for presenting augmented-reality-based offer to a user according to an implementation described herein.

### DETAILED DESCRIPTION OF PREFERRED EMBODIMENTS

The following detailed description refers to the accompanying drawings. The same reference numbers in different drawings may identify the same or similar elements.

Systems and methods provided herein may provide actionable offers that are applicable in an immediate vicinity to a user device. A user (e.g., subscriber) of the user device may set preferences to locally control the types of offers that are presented to the user. In one implementation, offers are presented to the user in an augmented reality environment.

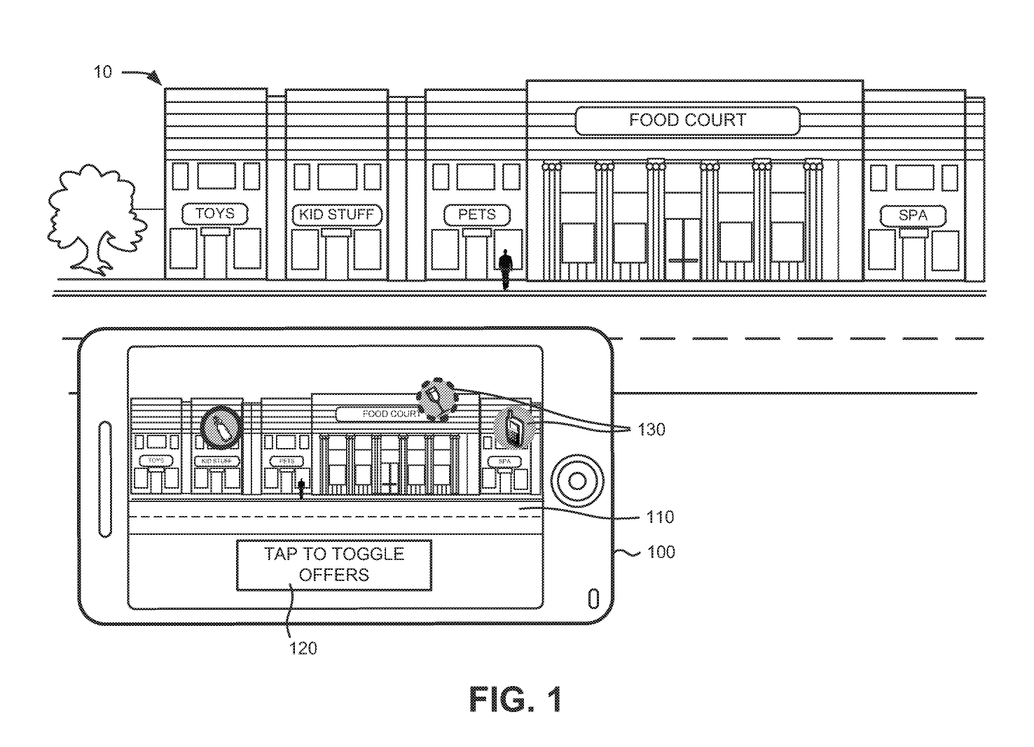

FIG. 1 is a diagram of illustrating concepts described herein. As shown in FIG. 1, a user device 100 may employ an augmented reality system so that an image 110 of the ground-truth (or reality) 10 is viewed on user device 100. User device 100 may provide a control section 120 to toggle on/off the display of proximity-based offer icons 130. To provide an augmentation experience to the user, each of offer icons 130 may be overlaid on a portion of image 110 that is associated with an offer location. An offer location may be, for example, a location of an advertiser (e.g., a particular store, restaurant, franchise, etc.) or a location where products of advertisers are sold (e.g., any store that sells a particular advertised product or brand). As used herein, an “offer” may include an advertisement or a promotion to induce a sale. In some implementations, systems and methods described herein may provide incentive fees (or other incentives) to reward the user of user device 100 for electing to view offers presented on user device 100.

As described further herein, user device 100 may identify particular offer icons 130 to present from a larger set of available offers provided to user device 100 by the service provider. For example, a service provider may identify relevant offers available in a vicinity of user device 100 based on both the location and reality view direction of user device 100. From the set of relevant offers, user device 100 may select particular offer icons 130 to present based on, for example, user preferences, advertisers' incentive fees, and predictive scoring. In one implementation, offer icons 130 may represent categories of offers that may be of interest to the user. Offer icons 130 may be differentiated to identify categories of potentially high interest to the user (e.g., based on a user profile and the offer content) from those of lower interest. For example, offer icons 130 may be color-coded to differentiate each presented offer category from most-likely to least-likely to be of interest to the user. In other implementations, offer icons may be differentiated based on different sizes, intensities, shapes, outlines, animation, etc.

The user may select one of offer icons 130 to view and redeem offers within the selected category. In one implementation, each of the offers presented to the user may be subject to an incentive fee, assessed to the advertiser sponsoring the offer. That is, advertisers may negotiate fees to present offers to users. When an offer is viewed, user device 100 may notify the service provider to process the incentive fee. The incentive fee may be proportionately allocated, for example, between a service provider handling fee and monetary inducement for the user. The user's portion of the incentive fee may be credited to a user account with the service provider.

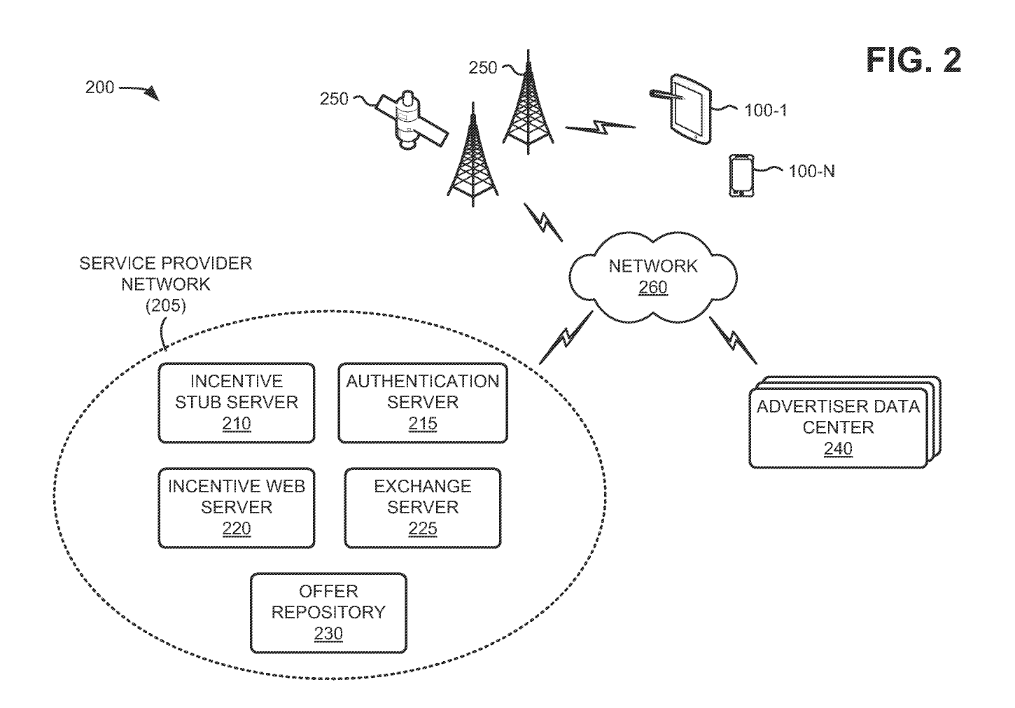

FIG. 2 is a diagram illustrating an exemplary network 200 in which systems and/or methods described herein may be implemented. As illustrated, network 200 may include user devices 100-1 through 100-N (collectively “user devices 100” and individually “user device 100”), a service provider network 205 that includes a incentive stub server 210, an authentication server 215, an incentive web server 220, an exchange server 225, and an offer repository 230; an advertiser data center 240; and positioning devices 250; interconnected by a network 260. Components of network 200 may be connected via wired and/or wireless links.

User device 100 may include a computational or communication device. User device 100 may include, for example, a personal communications system (PCS) terminal, a tablet computer, a smartphone, a laptop computer, a gaming console, a global positioning system (GPS) device, a content recording device (e.g., a camera, a video camera, etc.), or other types of mobile computational or communication devices. In another implementation, user device 100 may include a fixed-location computing device, such as a desktop computer, or a fixed-location computing device in communication with a mobile accessory (e.g., a camera in wireless communication with a personal computer).

User device 100 may generally be equipped with hardware and software to provide location detecting capabilities and to present an augmented reality environment. User device 100 may be configured to solicit and store user preferences for advertising/offer categories. User device 100 may apply the user preferences to a default set of proximity-based offers received from service provider network 205 to identify applicable offers most likely to be of interest to a user. User device 100 may present indications of the applicable offers within an augmented reality environment and may notify service provider network 205 if particular offers are viewed/accepted.

Service provider network 205 may include network devices to provide backend services to user devices 100 for an augmented-reality-based offer management system. Service provider network 205 may include, for example, one or more private IP networks that use a private IP address space. Service provider network 205 may include a local area network (LAN), an intranet, a private wide area network (WAN), etc. In one implementation, service provider network 205 may implement one or more Virtual Private Networks (VPNs) for providing communication between, for example, any of incentive stub server 210, authentication server 215, incentive web server 220, exchange server 225, and offer repository 230. Service provider network 205 may be protected/separated from other networks, such as network 260, by a firewall. Although shown as a single element in FIG. 2, service provider network 205 may include a number of separate networks.

Incentive stub server 210 may include a network device to provide an interface between backend devices of service provider network 205 and user devices 100. In one implementation, incentive stub server 210 may include a library of code used for receiving and executing commands from a stub client (e.g., residing on user device 100). Incentive stub server 210 may provide an initial interface to user devices 100 attempting to access augmented-reality-based offers available through service provider network 205. Incentive stub server 210 may, for example, direct service requests from user devices 100 to authentication server 215 and/or incentive web server 220. In one implementation, the interactions between incentive stub server 210 and user devices 100 may be performed using hypertext transfer protocol (HTTP) or HTTP secure (HTTPS) via network 260.

Authentication server 215 may include a network device to provide backend support for authorizing use of augmented-reality-based offers by user devices 100. For example, authentication server 215 may store identification information for registered user devices 100 to verify that a particular user device 100 has access to augmented-reality-based offers provided by service provider network 205. Upon verifying eligibility of user device 100, authentication server 215 may, for example, provide a link (e.g., a URL) to permit user device 100 to access other devices in service provider network 205 to exchange augmented-reality-based offer information.

Incentive web server 220 may include a network device to manage service requests from eligible user devices 100. In one implementation, as described further herein, incentive web server 220 may receive service requests and may forward user device information (e.g., location data) from user device 100 to exchange server 225 for processing. In one implementation, incentive web server 220 may forward location information to exchange server 225 in a manner that provides for anonymity of user device 100 and/or the user. Incentive web server 220 may also receive data (e.g., a default offer set) from exchange server 225 and forward the data to user device 100 for processing/presentation.

Exchange server 225 may include a network device to receive location information associated with an eligible user device 100. Exchange server 225 may identify a set of offers (e.g., from offer repository 230) that are applicable to the proximity of user device 100 to an advertiser's presence (e.g., a store, etc.) and may score individual offers based on contextual data that is not particular to the user device. Contextual data may include, for example, fee information and time-based information that may influence a user's propensity to accept an offer. Exchange sever 225 may send to user device 100 (e.g., via incentive web server 220) some or all of the scored, proximity-based offers as a default offer set. Assuming a user selects an offer to view (or act upon), exchange server 225 may receive an indication of a user's selection from user device 100 to initiate processing, payment, or billing associated with the offer.

Offer repository 230 may include a database or another data structure to store advertisements and associated metadata that may be used (e.g., by exchange server 225) for providing offers. For example, advertisements in offer repository 230 may include category information, location information, incentive fees (or fee ranges), applicable time periods, key words, and/or other metadata to enable exchange server 225 and/or user device 100 to identify relevant advertisements for potential presentation to a user. Category information may include one or more standardized advertising categories (e.g., as defined by the Interactive Advertising Bureau (IAB) or another entity). Location information may include one or more relevant locations for the offer with sufficient detail to enable icon presentation in an augmented reality display. Incentive fees may include a monetary amount the sponsor is willing to pay to have the offer presented on user device 100. Incentive fees may be set differently for different offers and may vary based on the user ranking applied (on user device 100) to a category for the offer. Applicable time periods may be times of day (e.g., corresponding to mealtimes, business hours, etc.), particular types of days (e.g., Fridays, weekdays, weekends, holidays, etc.), etc. Keywords may include other offer data to permit differentiation of offers within the same categories. Offers and associated data stored in offer repository 230 may be provided, for example, to service provider network 205 via advertiser data center 240.

Advertiser data center 240 may include a device associated with a third party advertiser that sponsors offers for presentation to user devices 100. For example advertiser data center 240 may include computers or other communication devices to provide advertisements and/or metadata for offer repository 230. In one implementation, advertiser data center 240 may also receive and/or process charges (e.g., incentive fees) for offers that are presented on user devices 100. In another implementation, advertiser data center 240 may receive offer consumption reports or other data compilations generated, for example, by exchange server 225 (or another device associated with service provider network 205).

Positioning devices 250 may include one or more devices configured to provide location information for user devices 100. In some implementations, location information may include, for example, GPS information or another form of global navigation satellite system (GNSS) information. In one implementation, positioning devices 250 may include one or more cellular towers, wherein user devices may retrieve location information in the form of cellular tower triangulation information. Additionally, or alternatively, positioning devices 250 may include a GPS satellite to determine a location of user device 100. In another implementation, a position determining entity (PDE) may assist user device 100 in determining its GPS coordinates by providing ephemeris data to allow faster identification of satellites within view of user device 100. In still other implementations, positioning devices 250 may include a device with a fixed address or location associated with a wired network connection or IP address. For example, user device 100 may report, as location data, a service set identifier (SSID) (e.g., associated with a local wireless router) to which user device 100 may be connected.

Network 260 may include a local area network (LAN); an intranet; the Internet; a wide area network (WAN), such as a cellular network, a satellite network, a fiber optic network, a private WAN, or a combination of the Internet and a private WAN; etc., that is used to transport data. Although shown as a single element in FIG. 2, network 260 may include a number of separate networks that function to provide services to user devices 100.

In FIG. 2, the particular arrangement and number of components of network 200 are illustrated for simplicity. In practice there may be more user devices 100, service provider networks 205, incentive stub servers 210, authentication servers 215, incentive web servers 220, exchange servers 225, offer repositories 230, advertiser data centers 240, positioning devices 250, and/or networks 260. For example, there may be hundreds or thousands of user devices 100.

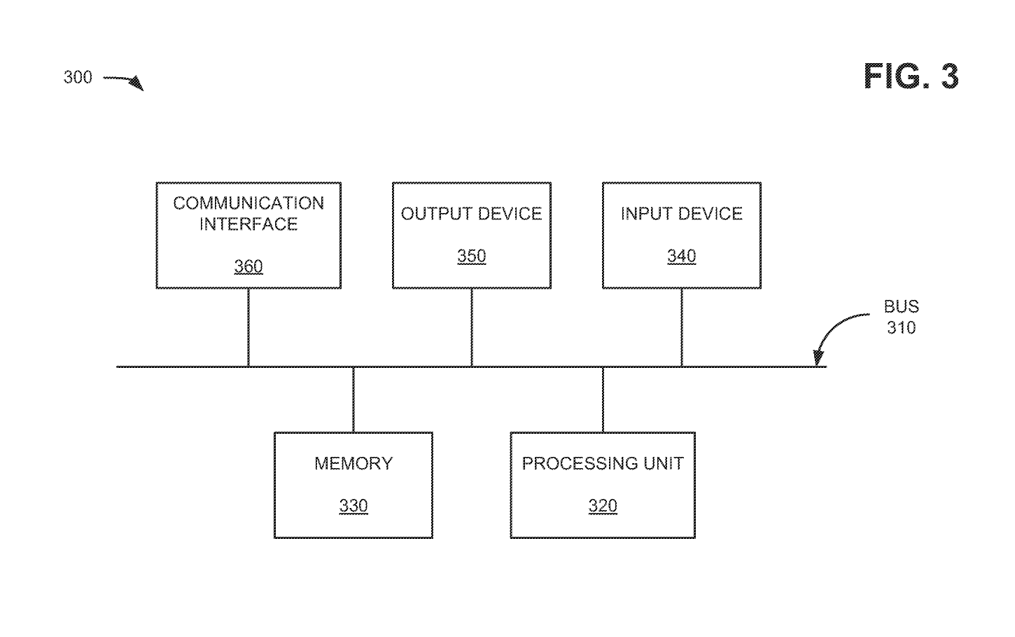

FIG. 3 is a diagram of exemplary components of a device 300. Each of user device 100, incentive stub server 210, authentication server 215, incentive web server 220, exchange server 225, offer repository 230, advertiser data center 240, and positioning device 250 may be implemented/installed as a combination of hardware and software on one or more of device 300. As shown in FIG. 3, device 300 may include a bus 310, a processing unit 320, a memory 330, an input device 340, an output device 350, and a communication interface 360.

Bus 310 may permit communication among the components of device 300. Processing unit 320 may include one or more processors or microprocessors that interpret and execute instructions. In other implementations, processing unit 320 may be implemented as or include one or more application specific integrated circuits (ASICs), field programmable gate arrays (FPGAs), or the like.

Memory 330 may include a random access memory (RAM) or another type of dynamic storage device that stores information and instructions for execution by processing unit 320, a read only memory (ROM) or another type of static storage device that stores static information and instructions for the processing unit 320, and/or some other type of magnetic or optical recording medium and its corresponding drive for storing information and/or instructions.

Input device 340 may include a device that permits a user to input information to device 300, such as a keyboard, a keypad, a mouse, a pen, a microphone, one or more biometric mechanisms, and the like. Output device 350 may include a device that outputs information to the operator, such as a display, a speaker, etc.

Communication interface 360 may include any transceiver-like mechanism that enables device 300 to communicate with other devices and/or systems. For example, communication interface 360 may include mechanisms for communicating with other devices, such as other devices of network 300.

As described herein, device 300 may perform certain operations in response to processing unit 320 executing software instructions contained in a computer-readable medium, such as memory 330. A computer-readable medium may include a non-transitory memory device. A memory device may be implemented within a single physical memory device or spread across multiple physical memory devices. The software instructions may be read into memory 330 from another computer-readable medium or from another device via communication interface 360. The software instructions contained in memory 330 may cause processing unit 320 to perform processes described herein. Alternatively, hardwired circuitry may be used in place of or in combination with software instructions to implement processes described herein. Thus, implementations described herein are not limited to any specific combination of hardware circuitry and software.

Although FIG. 3 shows exemplary components of device 300, in other implementations, device 300 may include fewer components, different components, differently arranged components, or additional components than those depicted in FIG. 3. As an example, in some implementations, a display may not be included in device 300. In these situations, device 300 may be a “headless” device that does not include input device 340. Alternatively, or additionally, one or more components of device 300 may perform one or more other tasks described as being performed by one or more other components of device 300.

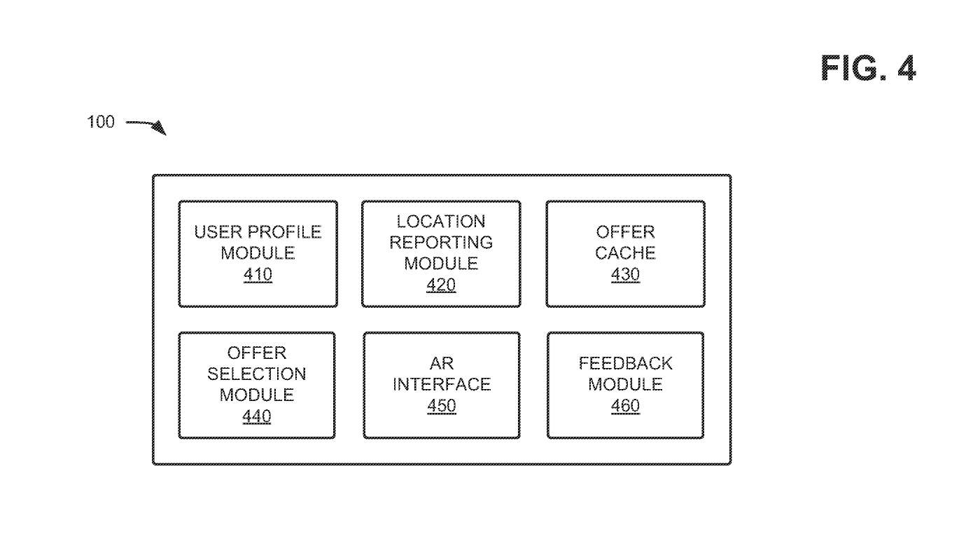

FIG. 4 is a block diagram of exemplary functional components of user device 100. The functional components may be implemented by, for example, processing unit 320 in conjunction with memory 330. As shown in FIG. 4, user device 100 may include a user profile module 410, a location reporting module 420, an offer cache 430, an offer selection module 440, an augmented reality (AR) interface 450, and a feedback module 460. User device 100 may also include other peripheral applications (not shown) associated with options that may be presented to users of user device 100. Peripheral applications may include, for example, a web browser, a file manager application, communications applications, a global positioning system (GPS) system, etc.

User profile module 410 may solicit user preferences of advertising categories and collect preference data based on user activity. User profile module 410 may also provide a user interface to allow a user to opt in or opt out of augmented-reality-based offers. User preferences may include a ranking of potential offer categories (e.g., yes/no interest, low/med/high interest, scale of 1-5, etc.). Offer categories may correspond to the same standardized categories used by sponsors for offers in offer repository 230. For example, categories in both user profile module 410 and offer repository 230 may be defined by the IAB or another standardized category set. User preferences may further include keywords or other criteria to rank offers within particular categories.

Location reporting module 420 may identify a location of user device 100 and provide location information to service provider network 205. For example, location reporting module 420 may provide GPS information, GSSN info, cell tower triangulation information, or a physical address associated with a network device (e.g., a wireless router, etc.). Location reporting module 420 may provide location information, for example, in response to a user activating augmented-reality-based offers on user device 100 or when location reporting module 420 identifies a change in location of user device 100. In one implementation, location reporting module 420 may include, in the location information, a viewing direction of a camera associated with user device 100.

Offer cache 430 may store a default set of offers and/or metadata that are received from service provider network 205 in response to, for example, location information from location reporting module 420. Offer cache 430 may store the default set of offers in relation to a particular location and may overwrite offers when a new location/default offer set is received.

Offer selection module 440 may select, based on user preferences identified by user profile module 410 and availability within offer cache 430, particular offer categories to present to a user. For example, offer selection module 440 may select a manageable number of offers (e.g., two to five offers) that may be presented (e.g., via AR interface 450) to a user at a given time. In one implementation, offer selection module 440 may rate offers selected for display in accordance with the local preference for the category of the offer. For example, assume a user profile indicates a high preference for sporting goods offers and a moderate preference for camera offers. If offer selection module 440 selects both an offer for sporting goods and an offer for cameras, offer selection module 440 may rate the sporting goods offer as a ‘better’ offer than the camera offer. As described further below, the offer rating may be used by service provider network 205 to calculate incentive fees for display of offers.

AR interface 450 may collect and/or process information from camera(s), sensors, navigation/position systems, and/or other components of user device 100 (not shown) to provide an augmented reality presentation. In one implementation, AR interface 450 may collect depth, position, and orientation information as raw position data and may rely a remote AR support device (e.g., a computational device associated with service provider network 205 or another network) for calculating small-scale positions. Based on the raw position data, AR interface (or the remote AR support device) may calculate a position associated with user device 100. Generally, AR interface 450 may use the calculated position to accurately project additional position-based AR information, such as offer icons 130, over current reality image 110. AR interface 450 may operate in combination with other functional components of user device 100 to render the augmented-reality-based offers in real time or near real time.

AR interface 450 may identify screen locations on user device 100 (e.g., overlaying image 110) that correspond to offers identified by offer selection module 440. When requested by a user (e.g., via control section 120) AR interface may present offer icons (e.g., offer icons 130) for the identified offers on the screen locations overlaying image 110. In one implementation, AR interface 450 may present generic offer icons corresponding to the category of the offers selected by offer selection module 440. In another implementation, the offer icons may be specifically associated with a particular sponsor of the offer.

If offer selection module 440 has rated the offer categories, AR interface 450 may also include a rating indication, such an outline color or additional icon, with icon 130 to indicate the rating. For example, icons of highly preferred categories may be outlined in green, icons of less preferred categories may be outlined in orange, and icons for categories with no indication of preference may be outlined in red. When user selects a particular icon, AR interface 450 may retrieve the corresponding offer information from offer cache 430 and present the offer associated with the selected icon.

Feedback module 460 may track selection of offers by a user. In one implementation, feedback module 460 may provide selection information to user profile module 410 for profile updates. In another implementation, feedback module 460 may provide selection information to service provider network 205 for tracking and accounting purposes. Selection information may include, for example, an offer identifier, a user identifier, a time of selection, etc.

Although FIG. 4 shows exemplary functional components of user device 100, in other implementations, user device 100 may include fewer components, different components, or additional components than those depicted in FIG. 4. Alternatively, or additionally, one or more components of user device 100 may perform one or more other tasks described as being performed by one or more other components of user device 100.

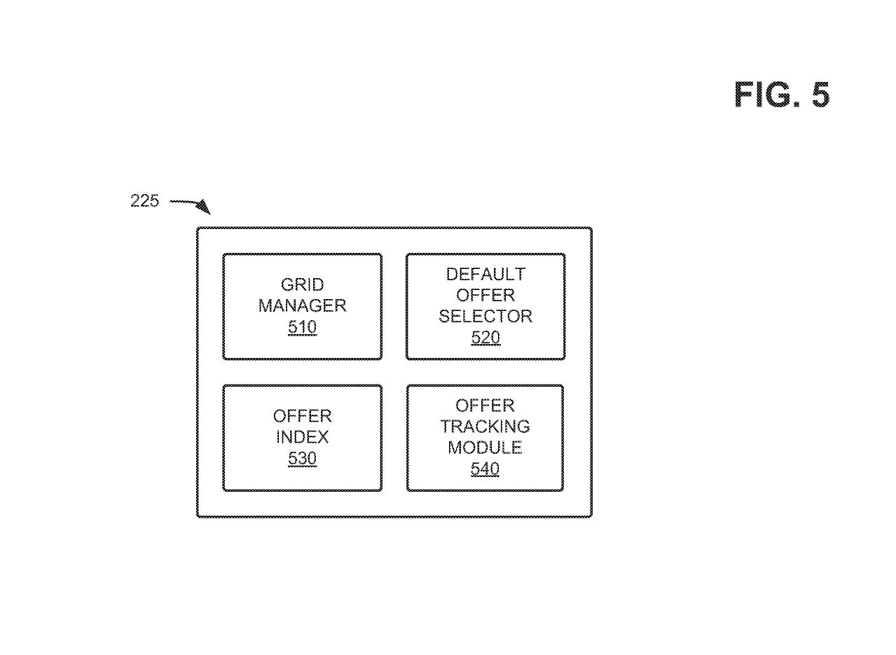

FIG. 5 is a block diagram of exemplary functional components of exchange server 225. The functional components may be implemented by, for example, processing unit 320 in conjunction with memory 330. As shown in FIG. 5, exchange server 225 may include a grid manager 510, a default offer selector 520, an offer index 530, and an offer tracking module 540.

Grid manager 510 may receive location information (e.g., of a user device 100) and identify one or more grid tiles that are relevant to user device 100. For example, service provider network 205 may track global or regional location information using a grid of particularly-sized tiles (e.g., 10 meter squares). Grid manager 510 may translate location information from user device 100 onto a particular grid tile. Offers from offer repository 230 may also be associated with particular grid tiles. Depending on whether location information includes a direction, grid manager 510 may identify all adjacent grid tiles or only particular adjacent grid tiles that may be relevant to user device 100.

Default offer selector 520 may identify offers (e.g., from offer index 530) in the relevant grid tiles identified by grid manager 510 to determine a proximity offer set. From the proximity offer set, default offer selector 520 may apply one or more algorithms to identify a default set of applicable offers for user device 100. The default set of applicable offers may be selected without respect to user preferences or knowledge of user device 100. For example, default offer selector 520 may apply criteria such as time of day (e.g., breakfast, lunch, and dinner times), day of week (e.g., weekday/weekend), offer selection history, and/or other contexts to rank offers within the proximity offer set. Default offer selector 520 may identify the highest ranked offers in the proximity offer set to form the default offer set.

Offer index 530 may store offer data (e.g., from offers in offer repository 230) that can be used by default offer selector 520 to identify a default set of applicable offers. Offer index 530 may, for example, include a flat data structure or a database that may include locations, keywords, categories, incentive fees, and other information associated with particular offers.

Offer tracking module 540 may receive offer selection information (e.g., from user device 100 via web server 220) and may monitor selection rates and other trends for particular offers and/or offer categories. In one implementation, offer tracking module 540 may provide selection rates and/or trend information to sponsors. Offer tracking module 540 may also determine if an incentive fee is associated with a viewed offer and initiate/assign payments to appropriate user accounts and debits to appropriate sponsor accounts.

Although FIG. 5 shows exemplary functional components of exchange server 225, in other implementations, exchange server 225 may include fewer components, different components, or additional components than those depicted in FIG. 5. Alternatively, or additionally, one or more components of exchange server 225 may perform one or more other tasks described as being performed by one or more other components of exchange server 225.

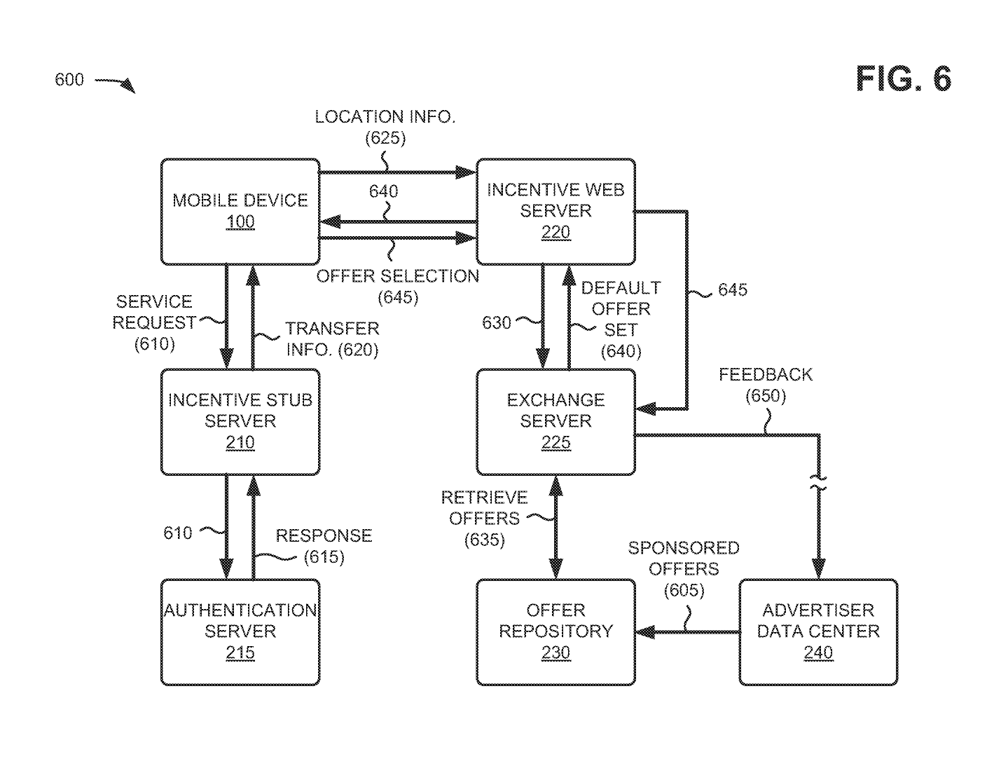

FIG. 6 is a diagram of exemplary communications for a portion 600 of network 200. Communications in FIG. 6 may represent communications to provide augmented-reality-based offers to user device 100. As shown in FIG. 6, network portion 600 may include user device 100, incentive stub server 210, authentication server 215, incentive web server 220, exchange server 225, offer repository 230, advertiser data center 240, and positioning device 250. User device 100, incentive stub server 210, authentication server 215, incentive web server 220, exchange server 225, offer repository 230, advertiser data center 240, and positioning device 250 may include functionality described above in connection with, for example, FIGS. 1-5.

As shown in FIG. 6, advertising data center 240 may submit sponsored offers 605 to offer repository 230. Sponsored offers 605 may include, for example, any proximity-based offer or another type of offer that may be presented to a user in association with an augmented reality environment. Sponsored offers 605 provided to offer repository 230 may be indexed for ranking/selection by, for example, exchange server 225 (e.g., default offer selector 520).

User device 100 may provide a service request 610 to incentive stub server 210. Service request 610 may include a request to participate in augmented-reality-based offers and an identifier (e.g., an MEID, a MAC address, a phone number, etc.) of user device 100. Incentive stub server 210 may forward service request 610 to authentication server 215 for authentication. Authentication server 215 may, for example, compare information in service request 610 to previously provided registration information to determine if user device 100 is authorized to participate in augmented-reality-based offers from service provider network 205. Assuming user device 100 is authorized, authentication server 215 may provide a response 615 to incentive stub server 210 to permit augmented-reality-based offers.

Incentive stub server 210 may receive response 615 and may, in turn, transfer user device 100 to incentive web server 220. For example, incentive stub server 210 may provide transfer information 620 to user device 100. Transfer information 620 may include, for example, a URL or another link to permit user device 100 to connect to incentive web server 220.

User device 100 may receive transfer information 620 and may use transfer information 620 to send location information 625 to incentive web server 220. Location information 625 may be provided, for example, via location reporting module 420. Location information 625 may include, for example, a particular location (e.g., GPS coordinates, physical address, etc.) or a grid identification (e.g., a generalized identification of being within a defined area) associated with user device 100. In one implementation, location information 625 may also include direction information (e.g., a direction that a camera of user device 100 is facing).

Incentive web server 220 may receive location information 625 and, if necessary, process the location information. For example, incentive web server 220 may strip device identification information from the location information 625 to ensure anonymity of user device 100 and its respective user. In another implementation, incentive web server 220 may generalize location information 625 (e.g., to identify a grid tile instead of a specific area) to safeguard privacy. Incentive web server 220 may forward the raw or processed location information to exchange server 225 as location data 630.

Exchange server 225 may receive location data 630 and may determine a superset of applicable default offers that are available in the proximity of the identified location. For example, default offer selector 520 may search offer index 530 to identify offers available in the proximity of user device 100 (e.g., as indicated by location data 630) and may score/filter those offers based on non-user specific factors. Exchange server 225 may retrieve (e.g., from offer repository 230) offers 635 selected for inclusion as a default offer set and may provide default offer set 640 to incentive web server 220. Incentive web server 220 may, if necessary, associate default offer set 640 with user device 100 and forward default offer set 640 to user device 100.

User device 100 may receive/store default offer set 640. User device 100 (e.g., offer selection module 440) may apply information from user profile module 410 to determine particular offer categories to present to the user via AR interface 450. Assuming the user selects/views an offer, user device 100 may provide an indication of an offer selection 645 to incentive web server 220. Incentive web server 220 may provide offer selection 645 to exchange server 225 (or one or more other backend processing systems) for incentive fee tracking, fee billing (e.g., to sponsors), and fee distribution (e.g., to user/subscriber accounts). Based on, for example, a number of default offer sets 640 and offer selections 645, exchange server 225 may compile success rates and other statistics which may be provided directly or indirectly to advertiser data center 240 as feedback 650.

Although FIG. 6 shows exemplary components of network portion 600, in other implementations, network portion 600 may include fewer components, different components, differently-arranged components, and/or additional components than depicted in FIG. 6. Alternatively, or additionally, one or more components of network portion 600 may perform one or more other tasks described as being performed by one or more other components of network portion 600.

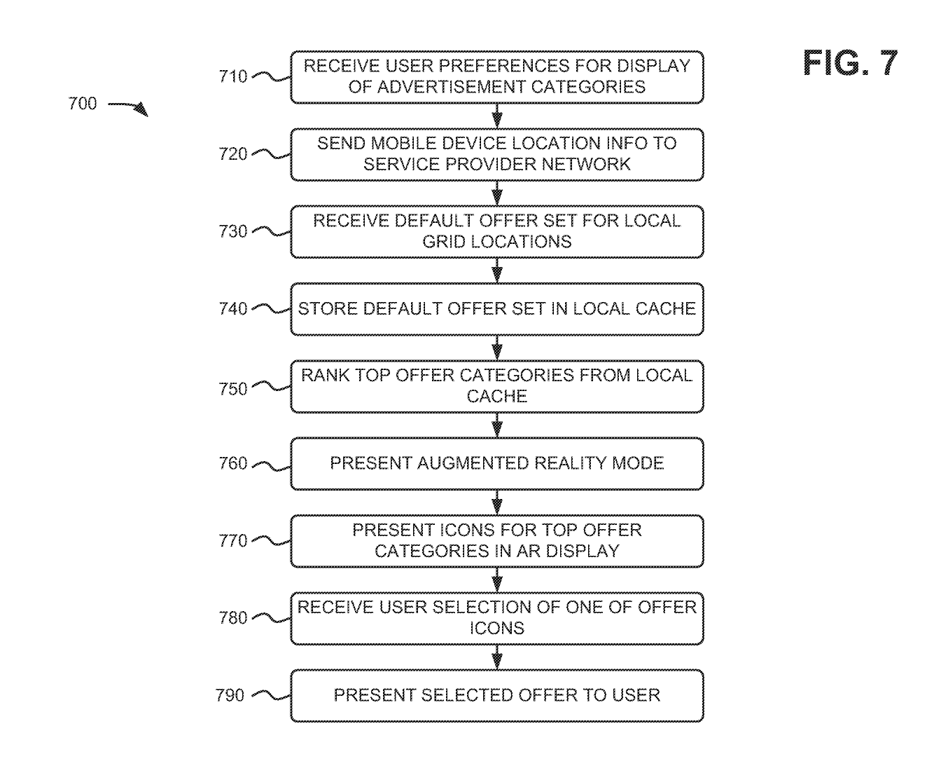

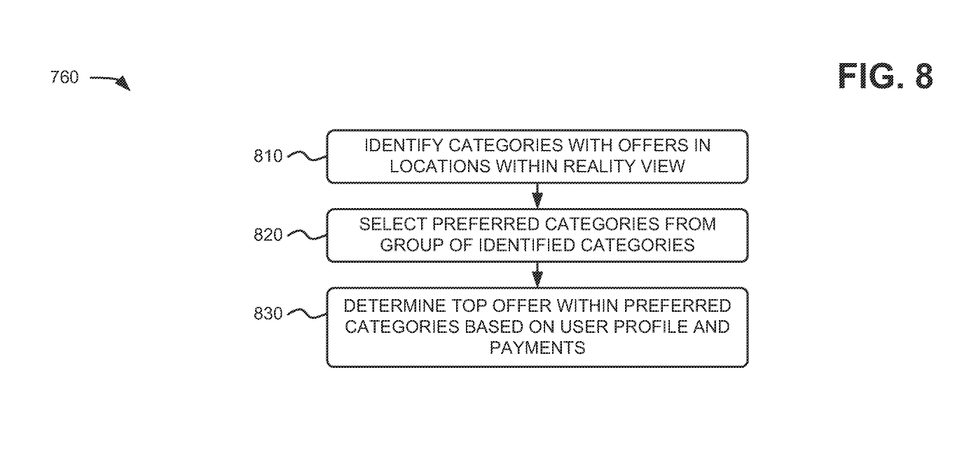

FIGS. 7 and 8 are flow diagrams of an exemplary process 700 for presenting offers via a user device in an augmented-reality-based system. In one implementation, process 700 may be performed by user device 100. In another implementation, some or all of process 700 may be performed by another device or group of devices, including or excluding user device 100. For example, a device in service provider network 205 may perform one or more parts of process 700.

As shown in FIG. 7, process 700 may include receiving user preferences for display of advertisement categories (block 710) and sending user device location information to a service provider network (block 720). For example, as described above in connection with FIG. 4, user device 100 (e.g., user profile module 410) may solicit user preferences of advertising categories and collect preference data based on user activity. Location reporting module 420 may identify a location of user device 100 and provide location information to service provider network 205 (e.g., incentive web server 220).

Process 700 may further include receiving a default offer set for local grid locations (block 730), and storing the default offer set in a local cache (block 740). For example, as described above in connection with FIGS. 4 and 6, exchange server 225 may provide a default set of offers to user device 100 in response to location information from location reporting module 420. User device 100 (e.g., offer cache 430) may store a default set of offers and/or metadata that are received from service provider network 205.

Process 700 may further include ranking top offer categories from local cache (block 750). For example, as described above in connection with FIG. 4, offer selection module 440 may select, based on local preferences identified by user profile module 410 and availability within offer cache 430, particular offer categories to present to a user.

Process 700 may also include presenting an augmented reality mode (block 760) and presenting icons for the top offer categories in the augmented reality display (block 770). For example, as described above in connection with FIG. 4, AR interface 450 may identify screen locations on user device 100 (e.g., overlaying image 110) that correspond to offers identified by offer selection module 440. When requested by a user (e.g., via control section 120) AR interface may present offer icons for the identified offers on the screen locations overlaying image 110.

Process 700 may include receiving a user selection of one of the offer icons (block 780) and presenting the selected offer to the user (block 790). For example, as described above in connection with FIG. 4, feedback module 460 may provide selection information to service provider network 205 for tracking and accounting purposes. Selection information may include, for example, an offer identifier, a user identifier, a time of selection, etc.

Process block 760 may include the process block shown in FIG. 8. Referring to FIG. 8, process block 760 may include identifying categories with offers in locations within reality view (block 810), selecting preferred categories from the group of identified categories (block 820), and determining a top offer within the preferred categories based on the user profile and payments (block 830). For example, as described above in connection with FIG. 4, offer selection module 440 may select a manageable number of offers that may be presented to a user at a given time. In one implementation, offer selection module 440 may rate offers selected for display in accordance with the local preference for the category of the offer.

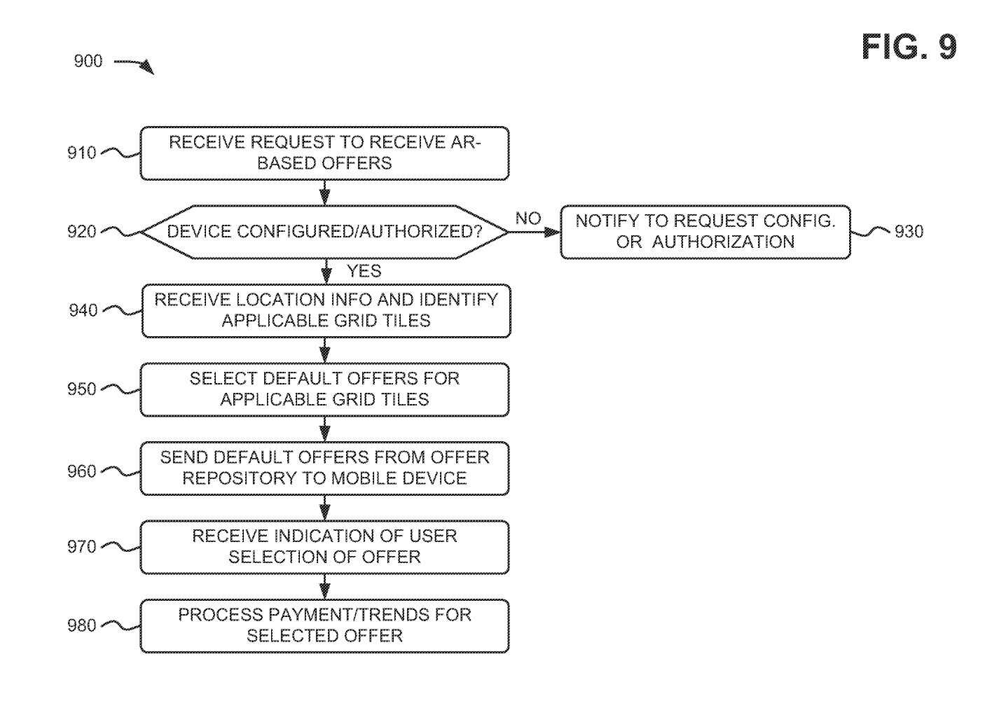

FIG. 9 is a flow diagram of an exemplary process 900 for presenting augmented-reality-based offers to a user according to an implementation described herein. In one implementation, process 900 may be performed by exchange server 225. In another implementation, some or all of process 900 may be performed by another device or group of devices, including or excluding exchange server 225. For example, another device in service provider network 205 may perform one or more parts of process 900.

As shown in FIG. 9, process 900 may include receiving a request to receive augmented-reality-based offers (block 910) and determining if the user device is configured and/or authorized to receive augmented-reality-based offers (block 920). For example, as described above in connection with FIG. 6, authentication server 215 may, for example, compare information in service request 610 from user device 110 to previously provided registration information to determine if user device 100 is authorized to participate in augmented-reality-based offers from service provider network 205.

If the user device is not configured and/or authorized to receive augmented-reality-based offers (block 920—NO), process 900 may include notifying the user to request configuration or authorization (block 930). For example, authentication server 215 may direct incentive stub server 210 to reject service request 610.

If the user device is configured and/or authorized to receive augmented-reality-based offers (block 920—YES), process 900 may include receiving location information and identifying applicable grid tiles (block 940). For example, as described above in connection with FIGS. 5 and 6, exchange server 225 (e.g., grid manager 510) may receive location data 630 and may determine a superset of applicable default offers that are available in the proximity of the identified location. For example, default offer selector 520 may search offer index 530 to identify offers available in the proximity of user device 100 (e.g., as indicated by location data 630) base on predetermined grid tiles.

Process 900 may further include selecting default offers for the applicable grid tiles (block 950), and sending default offers from an offer repository to the user device (block 960). For example, as described above in connection with FIGS. 5 and 6, exchange server 225 (e.g., default offer selector 520) may identify offers (e.g., from offer index 530) in the relevant grid tiles identified by grid manager 510 to determine a proximity offer set. From the proximity offer set, default offer selector 520 may apply one or more algorithms to identify a default set of applicable offers for user device 100. Exchange server 225 may retrieve (e.g., from offer repository 230) offers 635 selected for inclusion as the default offer set and may provide default offer set 640 to incentive web server 220. Incentive web server 220 may, if necessary, associate default offer set 640 with user device 100 and forward default offer set 640 to user device 100.

Process 900 may also include receiving a user selection of an offer (block 970), and processing payment and/or trends for the selected offer (block 980). For example, offer tracking module 540 may receive offer selection information (e.g., from user device 100 via web server 220) and may monitor selection rates and other trends for particular offers and/or offer categories. In one implementation, offer tracking module 540 may provide selection rates and/or trend information to sponsors. Offer tracking module 540 may also determine if an incentive fee is associated with a viewed offer and initiate/assign payments to appropriate user accounts and debits to appropriate sponsor accounts.

According to implementations described herein, a network device may receive location information from a user device and may identify, from an index of offers, a set of offers applicable in proximity to the location. Each offer in the set of offers may include location data to associate the offer with a particular geographic location. The network device may send, to the user device, at least a portion of set of offers as a default offer set. The user device may store user preferences for advertising categories and may present, to a user, a reality image from the location of the user device. The user device may select—based on the user preferences, the reality image, and the location data—offers in the default offer set that are applicable to a user of the user device. The user device may display indications of the applicable offers overlaid on a portion of the reality image and makes the indications available for selection by the user.

Systems and/or methods described herein may provide proximity-based offers in a user-centric manner. Users may view offers in their immediate vicinity without disclosing their identity or interest directly to the offer sponsor. The user may establish a private profile and may earn a fee for allowing an offer to appear on the user device. An augmented reality overlay allows for an intuitive view of where the offer can be redeemed physically, as well as a prioritization in terms of the value offered to the subscriber.

In the preceding specification, various preferred embodiments have been described with reference to the accompanying drawings. It will, however, be evident that various modifications and changes may be made thereto, and additional embodiments may be implemented, without departing from the broader scope of the invention as set forth in the claims that follow. The specification and drawings are accordingly to be regarded in an illustrative rather than restrictive sense. For example, while a series of blocks has been described with respect to FIGS. 7-9, the order of the blocks may be modified in other implementations. Further, non-dependent blocks may be performed in parallel.

It will be apparent that different aspects of the description provided above may be implemented in many different forms of software, firmware, and hardware in the implementations illustrated in the figures. The actual software code or specialized control hardware used to implement these aspects is not limiting of the invention. Thus, the operation and behavior of these aspects were described without reference to the specific software code—it being understood that software and control hardware can be designed to implement these aspects based on the description herein.

Further, certain portions of the invention may be implemented as a “component” or “system” that performs one or more functions. These components/systems may include hardware, such as a processor, an ASIC, or a FPGA, or a combination of hardware and software.

No element, act, or instruction used in the present application should be construed as critical or essential to the invention unless explicitly described as such. Also, as used herein, the article “a” and “one of” is intended to include one or more items. Further, the phrase “based on” is intended to mean “based, at least in part, on” unless explicitly stated otherwise.

What is claimed is:

1. A method, comprising:
storing, by a user device, user preferences for advertising categories;
sending, from a user device to a service provider network, an indication of the location of the user device;
receiving, by the user device from the service provider network, a default offer set of offers in the proximity of the location;
selecting, by the user device and based on the user preferences, offers in the default offer set to create a set of applicable offers;
presenting, by the user device, a reality image associated with the location; and
displaying, by the user device, indications of the applicable offers overlaid on a portion of the reality image associated with the offers.

2. The method of claim 1, further comprising:
storing, by the user device, the default offer set.

3. The method of claim 1, wherein sending the indication of the location information includes a determining a viewing direction of a camera associated with the user device and providing the viewing direction with the indication of the location.

4. The method of claim 1, wherein each offer in the default offer set includes a proposed display fee to be paid by a sponsor of the offer when the offer is selected for viewing by the user.

5. The method of claim 4, wherein selecting offers in the default offer set includes:
identifying, based on the user preferences, minimal display fee thresholds for presenting, to the user, offers in particular advertising categories, and
determining if an offer in the default offer set has a display fee above a respective minimal display fee threshold.

6. The method of claim 1, wherein the indications are overlaid in a manner to indicate where the respected selected offers can be redeemed physically.

7. The method of claim 1, further comprising:
receiving, by the user device, a user's selection of one of the indications; and
presenting, by the user device, an offer associated with the selected indication.

8. The method of claim 1, wherein each offer in the default offer set includes data to associate the offer with a particular geographic location and a particular advertising category.

9. A method, comprising:
receiving, by one or more network devices, information from a user device indicating a location;
identifying, by one or more network devices and from an index of offers, a set of offers applicable to the proximity of the location;
scoring, by one or more network devices, individual offers within the set of offers based on contextual data not particular to the user device;
sending, by one or more network devices and to the user device, at least a portion of the scored set of offers as a default offer set; and
receiving, by one or more network devices and from the user device, an indication of a user's selection of a particular offer from the default offer set.

10. The method of claim 9, further comprising:
identifying one or more grid tiles applicable to the location information, wherein each grid tile represents a particular physical area.

11. The method of claim 9, further comprising:
processing the indication of the user's selection with other users' selections to identify selection trends.

12. The method of claim 9, wherein the index of offers identifies a geographic location associated with each offer in the index of offers.

13. The method of claim 9, wherein the index of offers identifies a display fee for each of the offers, wherein the display fee is a monetary amount to be paid by a sponsor of the offer when a particular individual offer is selected by the user of the user device.

14. The method of claim 13, wherein the scoring of the individual offers is based on a value of the display fee associated with each of the individual offers.

15. A user device, comprising:
a network interface to communicate with one or more remote systems;
a display;
a camera to present a reality image;
one or more memories to store instructions; and
one or more processors configured to execute instructions in the one or more memories to:
store, in the one or more memories, user preferences for advertising categories,
send, to a service provider network, a location indication,
receive, from the service provider network, a default offer set of offers in the physical proximity of the location indication, wherein each of the offers includes location data to associate each offer with a particular geographic location and an advertising category, present a reality image from the camera to the display,
select, based on the user preferences, the reality image, and the location data, offers in the default offer set that are applicable to a user of the user device, and
display indications of the applicable offers overlaid on a portion of the reality image.

16. The user device of claim 15, wherein the one or more processors are further configured to execute instructions in the one or more memories to:
receive, from the user, a selection of one of the applicable offers, and
present, to the user, the selected offer.

17. The user device of claim 15, wherein each of the offers further includes a proposed display fee to be paid by a sponsor of the offer when the offer is selected for viewing by the user, and wherein the one or more processors are further configured to execute instructions in the one or more memories to:
rank the applicable offers within the same category based on the proposed display fee.

18. A system, comprising:
one or more network devices to:
receive information from a user device indicating a location;
identify from an index of offers, a set of offers applicable to the location, wherein each offer in the set of offers includes location data to associate the offer with a particular geographic location;
score individual offers within the set of offers based on contextual data not particular to the user device;
send, to the user device, at least a portion of the scored set of offers as a default offer set; and
receive, from the user device, an indication of a user's selection of a particular offer from the default offer set.

19. The system of claim 18, further comprising:
the user device configured to:
store user preferences for advertising categories;
present, to the user, a reality image from the location of the user device;
select, based on the user preferences, the reality image, and the location data, offers in the default offer set that are applicable to the user of the user device, and
display indications of the applicable offers overlaid on a portion of the reality image.

20. The system of claim 18, wherein the one or more network devices are further configured to:
rank offers in the default offer set based on a respective display fee value associated with each of the offers.
